(19) United States
(12) Patent Application Publication
(10) Pub. No.: US 2007/0085838 A1
(43) Pub. Date: Apr. 19, 2007

(54) Method for making a display with integrated touchscreen

(76) Inventors: Theodore K. Ricks, Rochester, NY (US); Philip J. Smith, Webster, NY (US)

Correspondence Address: Paul A. Leipold;Patent Legal Staff, Eastman Kodak Company, 343 State Street, Rochester, NY, 14650-2201, US

(21) Appl. No.: 11/252,167

(22) Filed: Oct. 17, 2005

(51) Int. Cl. G09G 5/00

(52) U.S. Cl. 345/173

(57) ABSTRACT

A method for making an electronically updatable touchscreen display having an electronically updatable display media and touch sensing capability is described.

### FIELD OF THE INVENTION

The present invention relates to a touch sensitive device with an electronically addressable display and methods for making such devices.

### BACKGROUND OF THE INVENTION

Since their conception in the 1970's, touch sensitive displays have grown into one of the most popular forms of user interface in the computing world. Kiosks, machine controllers, and personal digital assistants (PDAs), are just a few of the common devices that utilize this technology. Touch sensitive displays can have discrete touch sensitive areas, for example, operated by switch mechanisms, or can have continuous touch sensing over the surface of the display, referred to herein as a “touchscreen.” Touchscreens can detect multiple inputs over their entire surface, as compared to discrete touch sensitive devices, wherein each switch recognizes only a single input within the area of the switch. Touchscreens allow for higher resolution input recognition with simpler electronic circuitry than discrete touch sensitive devices. Touchscreen simplicity combined with display adaptability can be made to serve the function of a keyboard, mouse, pen, number pad, and many other input devices, all combined into a single unit. Today there are four most popular ways to make touchscreen displays: Resistive, Capacitive, Ultrasonic, and Infrared.

The resistive style consists of two clear conductors spaced apart by physical dots. When the assembly is depressed, the conductors touch and detectors determine the touch location by measuring the x and y resistance. This method is the least expensive and does not require a conductive stylus, but it suffers a reduction in optical transmission of up to 25%, providing a total transmittance of as low as 75%. Resistive touchscreens are typically manufactured independently of the final device for which they are used, as this is frequently the most cost effective manner for production. One way that this is accomplished is to coat two rolls or sheets of substrate material with a clear conductor, for example a sputter coated layer of Indium Tin Oxide (ITO), then screen print spacers and sensing electronics, and laminate the two substrates. In this manner, touchscreens can be made in an inexpensive, high-volume manner, then applied to any number of devices.

A second method for making a touchscreen is to use capacitive sensing. The capacitive style uses only one conductive layer arranged as the outermost layer of the device. Like in the resistive system, capacitive touchscreens can also be manufactured off-line, to be integrated later into the device. Capacitive touchscreens are advantageous because there is only one substrate, no spacers are required, and the optical transmissivity can be as much as 90%. Additionally, capacitive touchscreens can be easily fabricated integrally to the display by applying the conductive layer, for example, indium tin oxide (ITO), directly to the display front substrate. However, if this strategy is utilized, then special care must be taken with the handling of the display during fabrication, because there are functional layers on both sides of the substrate. This can quickly lead to significant handling problems, as ITO is notoriously prone to scratching. Additionally, once the assembly is formed, capacitive sensors are limited in that they require a conductive stylus, and the options for protective outer coatings on the conductive layer are very limited.

The final two popular methods for making a touchscreen, ultrasonic and infrared (IR) sensing, are very similar. Both styles use signal generators and receivers placed around the perimeter of the display. In the ultrasonic format, sonic waves are generated. In the IR format, infrared light beams are generated. In both, an array of beams or waves cover the surface of the display, and the sensors identify a touch location based on which beams are broken or what waves are bounced back. These systems cannot be integral to the display, and are rather separate components of a larger assembly. Their major advantage is that they do not require a conductive stylus and have no optical loss. However, given the large number of generators and sensors required, they are the most expensive of the options, and can be very sensitive to surface flatness. These issues make such touchscreens infeasible for use with inexpensive, flexible displays.

There are methods for allowing discrete touch input into a display device. The most common of these is a membrane switch. This is a method that is particularly popular with flexible displays, because it utilizes a series of individual electrical contacts, which are separated from complementary contacts by a gap. When the discrete contacts are depressed, they come in contact with their counterpart, completing a circuit. Although limited in their resolution, such sensors are simple to make and can be integrated into a flexible display. One example of this is in U.S. Pat. No. 6,751,898, where Heropoulos and Torma describe an electroluminescent display with integrated membrane switches. In their patent, they describe a device with at least one electrical contact, an insulator with holes corresponding to that contact, and a second conductor aligned to the first. When the display is depressed in the location of the contacts, a circuit is completed. This method is effective and inexpensive, but somewhat limited in overall application.

As was stated earlier, resistive and capacitive touchscreen display assemblies are typically created by manufacturing the display and touchscreen separately, then fastening or laminating the touchscreen to the front of the display. This method of assembly can be expensive, and the final product can be unnecessarily thick, especially if both display and touchscreen utilize glass substrates. It is possible to mitigate this effect by combining the back plane of the touchscreen and the front plane of the display. This is especially desirable in the capacitive system, as it reduces the touch-sensing portion of the display to a single layer of conductive material and the associated sensing electronics. However, the same limitations of capacitive touchscreens still apply. In addition, the conductive material must be transparent, and applied to the opposite side of the substrate from the display material. The fragility of many transparent conductors can make this a dangerous proposition, risking significant scratching during handling. This can be costly, as the transparent conductive materials are frequently expensive to make and deposit, with most requiring vacuum deposition in cleanroom environments. In addition, even the single layer of transparent conductor can cost around 10% of optical transparency in the view substrate. Resistive touchscreens may require less expensive electronics and can use non-conductive styluses, but they add an air gap, another conductor, and another substrate. This can result in a 25% loss in transparency, which can be a significant problem.

It would be desirable to have a method for making an inexpensive touchscreen display system with an integrated, continuous touch-sensor, without optical losses, costly materials, or complex handling issues.

### SUMMARY OF THE INVENTION

A method of manufacturing an electrically updatable touchscreen device is described, wherein the device includes a flexible display, a first conductive layer, one or more spacer, and a second conductive layer, and wherein the method of forming the electrically updatable touchscreen device includes obtaining a flexible display, forming the first conductive layer on the flexible display, forming one or more spacer on the first conductive layer, and forming the second conductive layer over the one or more spacer.

### ADVANTAGES

The touch sensitive device can be made at a reduced cost and increased robustness with improved optical properties of the display.

### BRIEF DESCRIPTION OF THE DRAWINGS

The invention as described herein can be understood with reference to the accompanying drawings as described below:

FIG. 1 is a side view of a traditional resistive touchscreen and display assembly;

FIG. 2 is a cross-section view of a flexible display laminated to a polymer-based touchscreen assembly;

FIG. 3 is a side view of a touchscreen display assembly with an integral first electrode and laminated second electrode;

FIG. 4 is a side view of a touchscreen display assembly with an integral first electrode and laminated second electrode, wherein the first electrode is shared with the display;

FIG. 5 is an isometric exploded view of the assembly from FIG. 3;

FIG. 6 is a front view of a traditional spacer design;

FIG. 7 is a front view of an alternative spacer design; and

FIG. 8 is an isometric view of flexible touchscreen display assembly.

The drawings are exemplary only, and depict various embodiments of the invention. Other embodiments will be apparent to those skilled in the art upon review of the accompanying text.

### DETAILED DESCRIPTION OF THE INVENTION

A touch-sensitive assembly and an electronic, rewritable display can be combined to form a touch-input device with updateable display capability. Such a device can be used in multiple applications including, but not limited to, kiosks, industrial controllers, data input devices, informational signage, or consumer products.

The device can include a touch input sensor. The sensor can be a mechanical actuator, an electrical sensor, or an electromechanical device. The sensor can be a resistive touchscreen, wherein two electrodes are held apart by a gap, and positional sensing occurs when the electrodes are brought into contact. The touchscreen can be a capacitive touchscreen, wherein positional sensing occurs when a conductive material with some finite capacitance contacts a conductive layer. The touchscreen can be partially or completely flexible.

The device can include one or more sheets of display media, hereafter referred to as “media,” capable of displaying an electronically updateable image. The media can have a first and second conductor. The first and second conductor can be patterned. The first conductor pattern can be defined as the “columns” of the display and the second conductor can be defined as the “rows” of the display. The rows and columns can interact to form a passive matrix, with a “pixel” being defined as each area where a row and column overlap. Alternatively, the media can be created to form individual pixels that are driven through the use of individual transistors, to form an active matrix. The media can be designed such that the electrical connections for the rows, columns, and/or transistors are made along one or more edge of the sheet. The media can be designed such that the display area defined by the active or passive matrix is larger than in any direction than the area required for electrical interconnects. The media can be assembled with electronic drivers to form a display. The display can be constructed such that it can be rolled or folded to reduce the assembly size for transportation or storage.

The display media can contain an electrically imageable layer containing an electrically imageable material. The electrically imageable material can be light emitting or light modulating. Light emitting materials can be inorganic or organic in nature. Suitable materials can include organic light emitting diodes (OLED) or polymeric light emitting diodes (PLED). Some suitable OLEDs and PLEDs are described in the following United States patents: U.S. Pat. Nos. 5,707,745, 5,721,160, 5,757,026, 5,998,803, and 6,125,226 to Forrest et al.; U.S. Pat. Nos. 5,834,893 and 6,046,543 to Bulovic et al.; U.S. Pat. Nos. 5,861,219, 5,986,401, and 6,242,115 to Thompson et al.; U.S. Pat. Nos. 5,904,916, 6,048,573, and 6,066,357 to Tang et al., U.S. Pat. Nos. 6,013,538, 6,048,630, and 6,274,980 to Burrows et al.; and U.S. Pat. No. 6,137,223 to Hung et al. The light modulating material can be reflective or transmissive. Light modulating materials can be electrochemical materials, electrophoretic materials such as Gyricon particles (U.S. Pat. Nos. 6,147,791, 4,126,854, and 6,055,091), electrochromic materials, or liquid crystal materials. Liquid crystal materials can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Other suitable materials can include thermochromic materials, charged particles (WO 98/41899, WO 98/19208, WO 98/03896, and WO 98/41898), and magnetic particles. Structures having stacked imaging layers or multiple support layers can be used to provide additional advantages in some cases, such as in forming color displays.

The display media can contain an electrically imageable material which can be addressed with an electric field and then retain its image after the electric field is removed, a property typically referred to as “bistable”. Particularly suitable electrically imageable materials that exhibit “bistability” are electrochemical materials, electrophoretic materials such as Gyricon particles, electrochromic materials, magnetic materials, or chiral nematic liquid crystals. Especially preferred are chiral nematic liquid crystals, which can be polymer dispersed.

The display media can be configured as a single color, such as black, white or clear, and can be fluorescent, iridescent, bioluminescent, incandescent, ultraviolet, infrared, or can include a wavelength specific radiation absorbing or emitting material. There can be multiple layers of imaging material. Different layers or regions of the imaging material may have different properties or colors. Moreover, the characteristics of the various layers may be different from each other. For example, one layer can be used to view or display information in the visible light range, while a second layer responds to or emits ultraviolet light. The nonvisible layers may alternatively be constructed of non-electrically modulated materials that have radiation absorbing or emitting characteristics. The imaging material preferably has the characteristic that it does not require power to maintain display of indicia.

Many imaging materials, for example, cholesteric liquid crystals, are pressure sensitive. If the display media is flexed, thereby applying pressure to the imaging material in the display, the display can change state, thereby obscuring the data written on the display, or the imaging materials can be destroyed, as in the case of electrophoretic display materials. Therefore, the display media needs to be such that it is not permanently modified by pressure.

U.S. Pat. No. 6,853,412 discloses a pressure insensitive display media containing a polymer dispersed liquid crystal layer. The polymer dispersed cholesteric layer includes a polymeric dispersed cholesteric liquid crystal (PDLC) material, such as the gelatin dispersed liquid crystal material. Liquid crystal materials disclosed in U.S. Pat. No. 5,695,682 can also be used if the ratio of polymer to liquid crystal is chosen to render the composition insensitive to pressure. Application of electrical fields of various intensity and duration can drive a chiral nematic material (cholesteric) into a reflective state, to a transmissive state, or an intermediate state. These materials have the advantage of maintaining a given state indefinitely after the field is removed. exemplary cholesteric liquid crystal materials can be MERCK BL112, BL118, or BL126, available from E.M. Industries of Hawthorne, N.Y. One method of making such emulsions using limited coalescence is disclosed in EP 1 115 026A.

As noted above, a chiral nematic liquid crystal composition may be dispersed in a continuous matrix. Such materials are referred to as “polymer dispersed liquid crystal” materials or “PDLC” materials. Such materials can be made by a variety of methods. For example, Doane et al. (Applied Physics Letters, 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a display cell and the material is then polymerized. Upon polymerization, the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid crystal material and polymer (a hydroxy functionalized polymethylmethacrylate) along with a crosslinker for the polymer are dissolved in a common organic solvent toluene and coated on an indium tin oxide (ITO) substrate. A dispersion of the liquid crystal material in the polymer binder is formed upon evaporation of toluene at high temperature. The phase separation methods of Doane et al. and West et al. require the use of organic solvents that may be objectionable in certain manufacturing environments. These methods can be applied to other imaging materials, such as electrophoretic materials, to form polymer dispersed imaging materials.

Each discrete polymer-dispersed portion of imaging material is referred to as a “domain.” The contrast of the display is degraded if there is more than a substantial monolayer of N*LC domains. The term “substantial monolayer” is defined by the Applicants to mean that, in a direction perpendicular to the plane of the display, there is no more than a single layer of domains between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the imaging layer in the display has more than a single domain (two or more domains) between the electrodes in a direction perpendicular to the plane of the display, compared to the amount of points (or area) of the display in the imaging layer at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

One example of display media has a single layer of imaging material along a line perpendicular to the face of the display, preferably a single layer coated on a flexible substrate. Such a structure, as compared to vertically stacked imaging layers each between opposing substrates, is especially advantageous for monochrome displays. Additionally, structures having stacked imaging layers can be used to provide additional advantages in some cases, such as colored displays.

A problem with typical touch sensitive display device manufacture is that the display and touch sensor are fabricated separately, and combined upon final assembly. This strategy typically necessitates the touchscreen be located in front of the display, and requires that the touchscreen and display be separate, complete units. This makes for an inefficient final assembly, in that there frequently are redundant substrates in the system, adding cost and potentially decreasing display performance. The display being located behind the touchscreen from the viewer's perspective is a result not only of the assembly method, but also of the display itself. Rigid displays require touchscreens to be located in front of the display, in order to maintain the ability to sense touches to a high level of resolution. If a flexible display is used, this requirement is lessened, but only if the system is designed to accommodate a rear touchscreen by having pressure insensitive imaging materials.

An ideal system would utilize an integrated, rear touchscreen that is fabricated concurrently with the flexible display media. Such a system works best with a pressure insensitive display media, which can be fabricated such that any electrical connections are located on the outside perimeter of the media sheet. One example of such a system is a passive matrix, cholesteric display as is described in U.S. Pat. Appl. Pub. US 2004/0246411.

A preferred manufacturing method for making this display, is to begin with a flexible substrate. The flexible substrate can be any flexible self- supporting material that supports the conductor. Typical substrates can include plastics, glass, or quartz. “Plastic” means a polymer, usually made from polymeric synthetic resins, which may be combined with other ingredients, such as curatives, fillers, reinforcing agents, colorants, and plasticizers. Plastic includes thermoplastic materials and thermosetting materials.

The flexible material must have sufficient thickness and mechanical integrity so as to be self-supporting, yet should not be so thick as to be rigid. Typically, the flexible substrate is the thickest layer of the display. Consequently, the substrate determines to a large extent the mechanical and thermal stability of the fully structured display.

The flexible substrate can be polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alkoxy) fluoropolymer (PFA), poly(ether ether ketone) (PEEK), poly(ether ketone) (PEK), poly(ethylene tetrafluoroethylene)fluoropolymer (PETFE), poly(methyl methacrylate), various acrylate/methacrylate copolymers (PMMA), or a combination thereof. Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton™ made by Japan Synthetic Rubber Co., Tokyo, Japan; Zeanor T™ made by Zeon Chemicals L.P., Tokyo Japan; and Topas™ made by Celanese A. G., Kronberg Germany. Arton™ is a poly(bis(cyclopentadiene)) condensate that is a film of a polymer. Alternatively, the flexible plastic substrate can be a polyester. A preferred polyester is an aromatic polyester such as dAryLite™ (Ferrania). Although various examples of plastic substrates are set forth above, it should be appreciated that the substrate can also be formed from other materials such as glass and quartz.

A layer of a clear conductor, such as Indium Tin Oxide (ITO), can be applied to the substrate and patterned if necessary. One example of patterning would be to use a laser system to etch the ITO, forming a series of electrically isolated columns. An active display material can be coated over some portion of the clear conductor, leaving just enough conductor exposed to make electrical contact. The display material could also be coated over the entire clear conductor, with selected portions removed in subsequent steps to expose an interconnect area. The passive matrix may then be completed by applying rows of a second conductive material onto the display material. These rows can be concurrently applied and patterned, such as would be the case with screen, inkjet, gravure, or flexographic printing methods, or it can be coated then patterned, as would be the case with laser or chemical etching. Depending on the imaging material, one of the conductive layers can be unpatterned. According to certain embodiments, only the first conductive layer may be present.

Although the embodiment described above is centered around using a polymer dispersed liquid crystal layer on a flexible polymer support, it will be understood by those practiced in the art that the display media can be any flexible, pressure insensitive, electronically updateable media. Examples of manufacturing methods for flexible, electronically updateable media include U.S. Pat. No. 6,661,563, which discloses a method of making a flexible display with microcapsules, and U.S. Pat. No. 6,933,098, which teaches roll-to-roll manufacture of electrophoretic or liquid crystal displays employing microcups.

The device can combine the media and touch sensor to form a touch sensor with visually updateable properties, or a display with touch input capability. The device can be assembled such that the media is placed between the user and the touch sensor. The media and the touchscreen can be formed as an integral unit. The components required to sense touch input can be applied directly to the display media. The touch components can be formed using the same manufacturing methods as are used in fabrication of the display, especially the display conductors. The touchscreen and media can be transparent, translucent, opaque, or a combination thereof. The touchscreen and media can be the same size or shape, or different sizes or shapes. The media and touchscreen can be completely or partially flexible. The media and touchscreen can be permanently or temporarily attached to drive electronics. The drive electronics for the media and touchscreen can be separate or integrated. Methods of forming the assembled touch sensitive device will be described with reference to the figures.

The display can be understood with reference to certain embodiments including a cholesteric liquid crystal display element, as depicted in the Figures and described below.

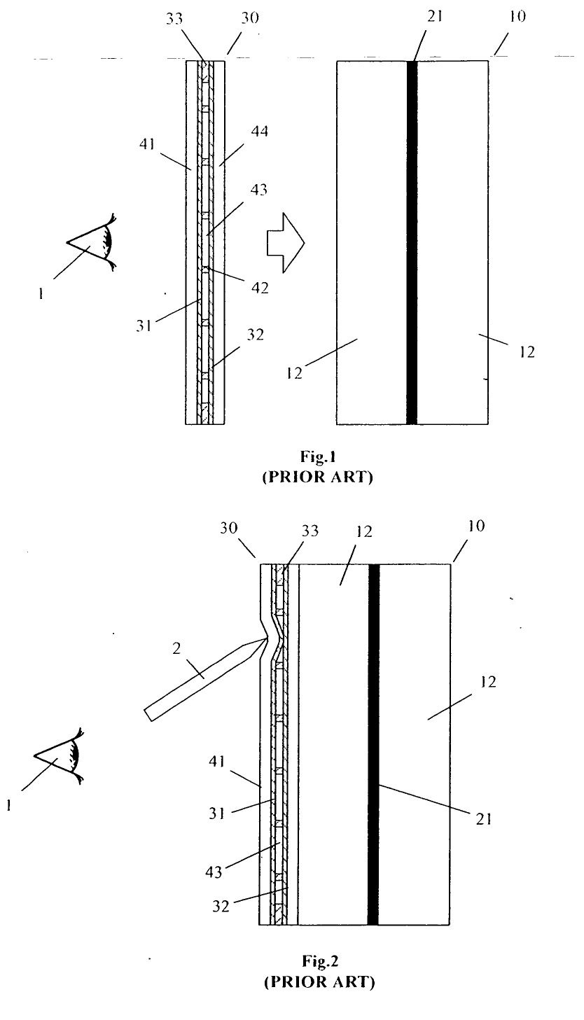

FIG. 1 shows a side view of a traditional touchscreen-display device as known in the art. In this embodiment, the device consists of a resistive touchscreen 30 applied to the viewer 1 side of a rigid display plane 10. The display plane consists of a first glass substrate 12, an active display layer 21, and a second glass substrate 12. The glass substrates are held at a specific distance from one another in any of a variety of ways, including, but not limited to, spacer beads, embedded fibers, polymer layers, or microfeatures. In the case when a touchscreen is to be added to the system, it is typically made as a separate assembly and attached to the display plane in subsequent steps. The resultant assembly is non-optimum because it has redundant substrates and, in most cases, an additional adhesive layer to adhere the touchscreen to the display. A resistive touchscreen 30 typically consists of a flexible, transparent, first substrate 41, a transparent first electrode 31, transparent spacers 42, sensing electrodes 33, a transparent second electrode 32, and a transparent, second substrate 44. The electrodes are typically indium tin oxide (ITO) sputter coated onto the substrate. The purpose of the spacers 42 is to keep the electrodes 31, 32 separated by an air gap 43. The reason for this will be explained with regard to FIG. 2.

Although the embodiment shown in FIG. 1 is a resistive touchscreen, a capacitive touchscreen could also be used. Capacitive touchscreens are similar to resistive touchscreens, except they consist of only a single electrode and substrate, with sensing electrodes located in the four corners of the assembly. The electrode for a capacitive touchscreen is typically located such to expose it to the viewer.

FIG. 2 shows a side view of a traditional, resistive touchscreen-display device as known in the art, with the touchscreen activated. An input device 2, such as a stylus or finger, applies pressure to the first substrate of the touchscreen 41, causing the substrate and first electrode 31 to deflect until the first electrode 31 comes into contact with the second electrode 32. As both electrodes 31, 32 are held at a given voltage, contact between them generates a current. The touchscreen sensing electrodes 33 measure the current generated and calculate the location of the touch, by extrapolating distance from the sensor 33 from a calculation using the sheet resistance of the first and second electrode 31, 32 materials. In this embodiment, the display 10 is not flexed, and the touchscreen 30 must be at least partially transparent for the display image to be viewed.

In the case that a capacitive touchscreen is used, sensing is done in a slightly different manner. In the capacitive system, the electrode surface is held at a specific voltage. When a conductive input device with some intrinsic capacitance contacts the electrode, the capacitor charges, causing current to flow. The sensors arrayed around the electrode measure this current flow, and calculate the position of the contact. The advantage to this system over the resistive method is that only one electrode and one substrate are required. The disadvantages are that the input device must be conductive and there are a very limited number of protective materials that can be placed over the electrode without interfering with touch input. Additionally, the electronics required to measure the touch are typically more complex than those used in a resistive system.

FIG. 3 shows an alternative system, in which a flexible display 10 is formed with an integral resistive touchscreen 30. The display can be is formed as was described previously, with a first display substrate 10, and an active display layer 21, consisting of a layer of display material coated between two electrode layers. The display can be given touch sensitive capability by adding a first touchscreen electrode 31, spacers 42, a second touchscreen electrode 32, optional touch sensing electrodes 33, and a second touchscreen substrate 44. An insulating layer (not shown) may have to be placed between the second display electrode 26 and the first touchscreen electrode 31 to prevent electrical interference or shorting. In this embodiment, the display substrate acts as the first touchscreen substrate, optimizing the assembly such that only two substrates are required. This is a significant improvement over the traditional touchscreen display, which required four substrates and an adhesive layer to complete the assembly. Methods for fabricating the individual layers will be described with regard to FIG. 5.

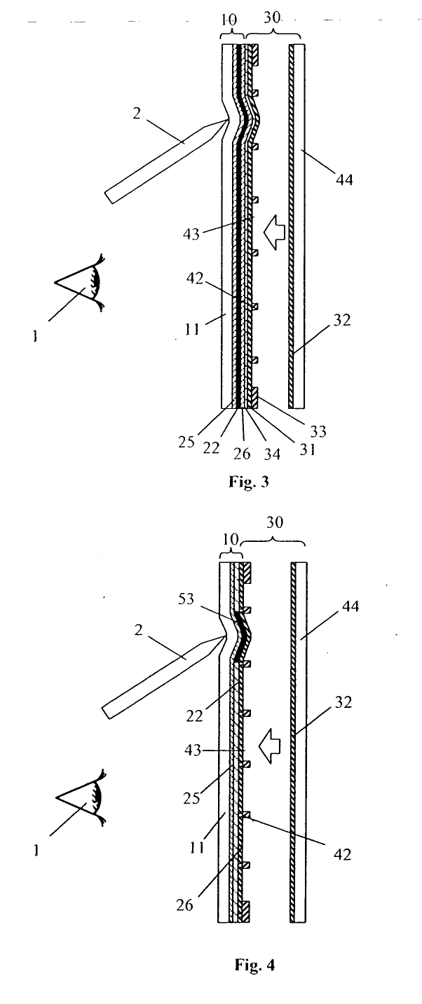

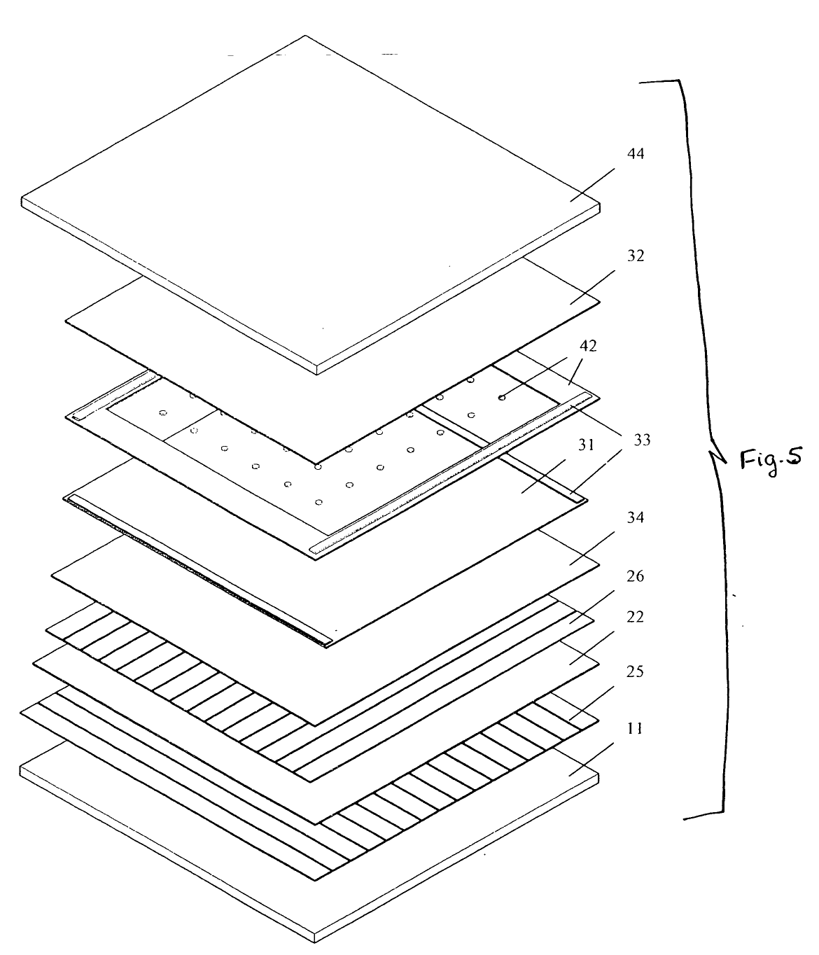

FIG. 4 illustrates an additional refinement, in which the system can be further optimized to combine the second display electrode and the first touchscreen electrode. Certain configurations of resistive or capacitive touchscreens could use contact of the second display electrode 26 to the second touchscreen electrode 32 to register a touch position. This configuration allows the spacers 42 to be applied directly to the second display electrode.

FIG. 5 shows an exploded isometric view of one embodiment of the touch-sensing display assembly. For reference, in this embodiment, the viewer would look through the first display substrate 11. However, if all layers are transparent, viewing could be through second touchscreen substrate 44. For some passive matrix systems, the display portion of the assembly can consist of the display substrate 11, the first display electrode 25, the display imaging layer 22, and the second display electrode 26. For some active matrix structures, the first and second display electrodes can be replaced with an active matrix, thin film transistor (TFT) layer. The display portion of the system can utilize in-plane switching, in which only the second conductive layer is used. The portion of the display that is to become touch sensitive should be flexible and somewhat pressure insensitive. Methods for forming the display may vary greatly depending on the display technology.

Once the display is formed, the touch sensitive components can be added. In this embodiment, a resistive system is shown. The structure begins with an insulating layer 34, which is applied to everything except the electrical contact areas required to drive the display. For the remainder of this description, it can be assumed that subsequent layers do not cover the display electrode electrical interconnects, and that the term “entire touchscreen area” refers only to the portion or portions of the assembly that are to be made touch-sensitive. The insulation layer is only required if the display portion of the assembly terminates in a conductive layer. The insulation layer 34 can be applied by screen printing, coating, lamination, vacuum deposition, ink jetting, stamping, or any other known method of application.

The first touchscreen electrode 31 is then applied. In a resistive system, this is a continuous conductive layer, which can be applied to the entire touchscreen area through screen printing, coating, vacuum deposition, ink jetting, gravure printing, or other methods.

The next layers include the spacers 42 and any sensing electrodes 33 required for the specific touch sensing method. For resistive touchscreens, the sensing electrodes 33 could be as simple as four highly conductive bus bars. For capacitive touchscreens, the required electrodes could be more complex, requiring several layers. The spacer and sensing electrode layers typically require specific patterning. This would encourage the use of a printing method, such as screen, inkjet, gravure, flexographic, or others to be used. If very high resolution is required, it is conceivable that layers could be vacuum deposited then patterned using photolithographic means. For most systems, the spacers can be relatively thick (10-20 microns), encouraging a thick film method of application such as screen printing to be used. However, the spacers can be thicker or thinner as appropriate for the specific system structure. The spacers can be formed on the first conductive layer, on a side of the second conductive layer to be adjacent the first conductive layer before application thereto, or a combination thereof.

According to one embodiment, the spacer layer serves a second duty as an adhesive layer. This allows the second touchscreen electrode 32 to be pre-coated as a continuous layer on the second touchscreen substrate 44, which can then be laminated to the spacer layer 42. If needed, sensing electrodes 33 can be applied to the second electrode and substrate assembly, the first electrode, one or more spacers, or a combination thereof. The sensing electrodes 33 can serve as an adhesive layer.

The system described in FIG. 5 is only one potential method of integrating the touchscreen with the display. As was stated previously, if a capacitive touchscreen is used, or if the second display electrode can be made to serve double duty, then it is conceivable that the insulation layer and first touchscreen electrode could be removed from the system. Additionally, if the second touchscreen electrode can be made sufficiently rigid to maintain the sensing gap between the touchscreen electrodes, then it can be conceived that the second touchscreen substrate could be likewise removed.

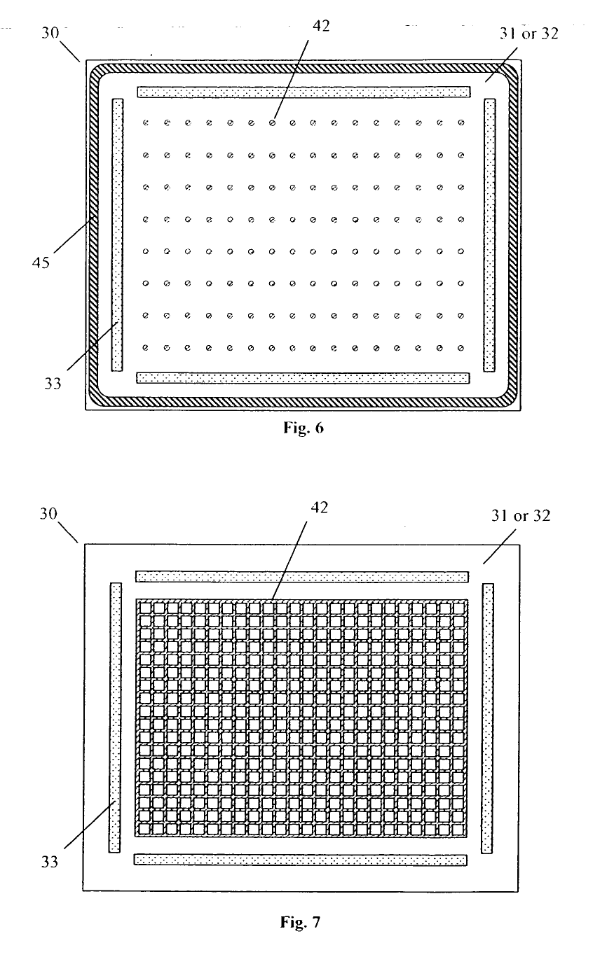

One area that has not been discussed in detail in this specification is the spacer. FIG. 6 is a front view of a typical spacer configuration on the touchscreen assembly 30 only. The display plane is not shown. In this embodiment the spacer 42 consists of an array of small, dots of a transparent, non-conductive material applied onto the first or second touchscreen electrode 31, 32, or both, depending on what type of touchscreen is used. The dots are typically as small and infrequent as possible, to minimize visual disruption of the display, in the traditional display-in-back assembly configuration. The spacers can be positioned throughout the display area, at the edges of the display area, outside the display area, or a combination thereof. The sensing electrodes 33 are typically arranged outside of the spacer 42 and viewing area perimeter, and can be inside or outside of the touchscreen seal 45. The seal 45 is typically a more robust and thicker adhesive than the spacer 42, and usually is the primary mechanism by which the system is held together, and may significantly contribute to maintaining a gap between the touchscreen electrodes. The dots typically cannot fulfill the mechanical bond portion of this function, as their small total area provides minimal bond strength. The seal 45 may also be required in certain environments to control the environment within the touchscreen gap. For example, in a high humidity environment, the seal may reduce humidity ingression and avoid fogging of the gap, which would reduce transmittance and could short the touchscreen.

There are several limitations to the dot-style spacer design. Aside from requiring the additional seal layer, the large gaps between dots can lead to touchscreen failure if the touchscreen is permanently or temporarily deformed, such as would happen if the material was folded, bent, or kinked. Additionally, if a high voltage touchscreen is used, then the electrostatic charge can cause the electrodes to become stuck to one another.

FIG. 7 is a front view of an alternative spacer design, which utilizes a grid instead of dots. This is possible in systems where the touchscreen is positioned behind the display, as it will not interfere optically with display viewing. In this embodiment, the spacer 42 is patterned to form a grid, which can be complementary to the patterns formed in the display electrodes. For example, it could be the perimeter of a single pixel, multiple pixels, or unrelated to the pixels. The advantage of the grid pattern is that it reduces the free span of the substrates, maintaining the touchscreen gap better than the dots when the assembly is bent or folded. Additionally, the increased surface area and complete perimeter may make the use of a touchscreen seal unnecessary. The grid also can be sized to overcome electrostatic forces in the high voltage system.

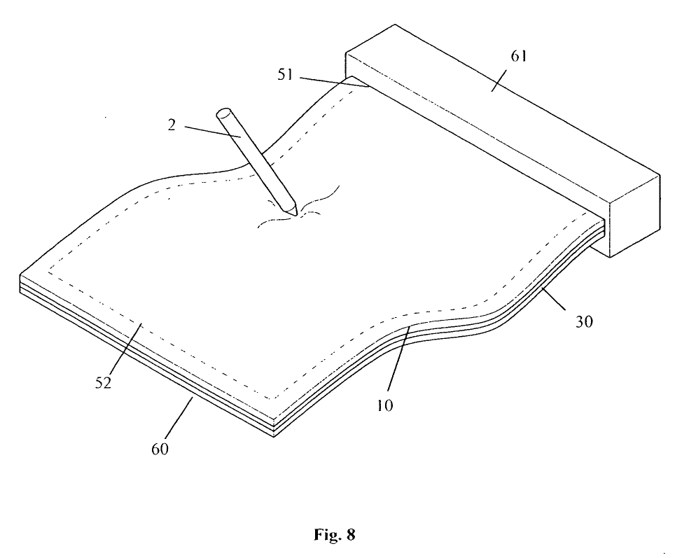

FIG. 8 is an isometric view of a potential final assembly utilizing many of the features described in this specification. The display 10 and touchscreen 30 can be connected along an interconnect edge 51 to drive electronics 61, forming a partially flexible touch-sensing display assembly 60 with an active display area 52. The pixel writing and sensing systems can be used to allow manual or automatic entry of data, and the grid spacer can maintain touchscreen gap regardless of assembly flexing. The final assembly can be flexible in space, application, or configuration, optimizing usefulness and cost for a multitude of systems.

The invention has been described in detail with particular reference to certain preferred embodiments thereof, but it will be understood that variations and modifications can be effected within the spirit and scope of the invention.

1. A method of manufacturing an electrically updatable touchscreen device comprising a flexible display, a first conductive layer, one or more spacer, and a second conductive layer, wherein the method of forming the electrically updatable touchscreen device comprises:
obtaining a flexible display;
forming the first conductive layer on the flexible display;
forming one or more spacer on the first conductive layer; and
forming the second conductive layer over the one or more spacer.

2. The method of claim 1, wherein the first conductive layer is formed as part of the flexible display.

3. The method of claim 2, wherein the display includes a substrate, a display conductive layer, and an imaging material, and wherein the first conductive layer is formed on the imaging material and cooperates with the display conductive layer to electronically update the imaging material.

4. The method of claim 1, wherein forming the one or more spacer and the second conductive layer comprises:
forming a conductive assembly comprising the second conductive layer and one or more spacer on the second conductive layer; and
adhering the conductive assembly to the first conductive layer.

5. The method of claim 4, wherein the conductive assembly further comprises a second substrate on which the second conductive layer and one or more spacer is formed.

6. The method of claim 1, wherein forming the touchscreen device further comprises forming a substrate on the second conductive layer.

7. The method of claim 1, further comprising forming an insulating layer between the flexible display and the first conductive layer.

8. The method of claim 1, wherein forming the touchscreen device further comprises forming one or more areas of different conductivity on the first conductive layer.

9. The method of claim 1, wherein the first conductive layer, the second conductive layer, or both can be formed by one or more of printing, coating, vapor depositing, masking, casting, molding, laminating, or a combination thereof.

10. The method of claim 1, wherein the one or more spacer comprises one or more dot, a grid, one or more bar, or a combination thereof.

11. The method of claim 1, wherein the electrically updatable touchscreen device is formed as a plurality of devices on a single sheet or roll.

12. The method of claim 1, wherein the flexible display comprises two or more displays.

13. The method of claim 1, wherein one or more portion of the display is covered by the first conductive layer, one or more spacer, and the second conductive layer.

14. The method of claim 1, wherein the display material comprises liquid crystal, organic light emitting diodes, electrophoretic material, magnetic material, electroluminescent material, electrowetting material, electrochromic material, or a combination thereof

15. The method of claim 1, wherein obtaining a flexible display comprises:
forming a substrate;
applying a display conductive layer to the substrate; and
applying an imaging material to the display conductive layer.
